(19) United States
(12) Patent Application Publication
(10) Pub. No.: US 2020/0339156 A1
(43) Pub. Date: Oct. 29, 2020

(54) VEHICLE CONTROL DEVICE, VEHICLE CONTROL METHOD, AND STORAGE MEDIUM

(71) Applicant: HONDA MOTOR CO., LTD., Minato-ku, Tokyo (JP)

(72) Inventors: Masamitsu Tsuchiya, Wako-shi (JP); Hiroshi Miura, Wako-shi (JP); Makoto Ishikawa, Wako-shi (JP); Koji Kawabe, Wako-shi (JP)

(21) Appl. No.: 16/769,595

(22) PCT Filed: Dec. 27, 2017
(86) PCT No.: PCT/JP2017/046913

§ 371 Date: Jun. 4, 2020

(51) Int. Cl. B60W 60/00; B60W 30/095; B60W 30/165; B60W 30/09; B60W 30/18

(52) U.S. Cl. CPC B60W 60/0016; B60W 30/0956; B60W 30/165; B60W 2554/80; B60W 30/18163; B60W 2552/00; B60W 30/09

(57) ABSTRACT

A vehicle control device includes: a recognizer configured to recognize a surrounding environment of an own vehicle; and a driving controller configured to perform driving control of the own vehicle with reference to a recognition result by the recognizer and configured to determine whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the recognizer recognizes the first vehicle which is traveling in front of the own vehicle in a first traveling lane in which the own vehicle is traveling and the obstacle which is in front of the first vehicle.

### TECHNICAL FIELD

The present invention relates to a vehicle control device, a vehicle control method, and a storage medium.

### BACKGROUND ART

In the related art, an invention of a vehicle control system including a vehicle controller that performs following control such that a vehicle follows a front vehicle has been disclosed. The vehicle control system includes a front vehicle determiner that determines whether the front vehicle changes its lane and a situation determiner that determines whether surroundings of the vehicle are in a situation where the change in the lane is possible. When the front vehicle changes lanes and the surroundings of the vehicle are in the situation where the change in the lane is possible, the vehicle controller causes the vehicle changing its lane to follow the front vehicle that has changed lanes and change lanes (for example, see Patent Literature 1).

### CITATION LIST

### Patent Literature

[Patent Literature 1]

Japanese Unexamined Patent Application, First Publication No. 2015-160554

### SUMMARY OF INVENTION

### Technical Problem

However, in the technology of the related art, in a scenario in which an obstacle is avoided while following another vehicle, how control is switched due to presence of still another vehicle traveling in a traveling lane of an approach destination was not considered. Therefore, smooth obstacle avoidance could not be realized in some cases.

The present invention is devised in view of such circumstances and an objective of the present invention is to provide a vehicle control device, a vehicle control method, and a storage medium capable of realizing smoother obstacle avoidance.

### Solution to Problem

(1) According to an aspect of the present invention, a vehicle control device (100) includes: a recognizer (130) configured to recognize a surrounding environment of an own vehicle; and a driving controller (150 or 160) configured to perform driving control of the own vehicle with reference to a recognition result from the recognizer and configured to determine whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the recognizer recognizes the first vehicle which is traveling in front of the own vehicle in a first traveling lane in which the own vehicle is traveling and the obstacle which is in front of the first vehicle.

(2) In the vehicle control device according to the aspect (1), the recognizer may predict whether the second vehicle intends to follow the first vehicle based on a state of the second vehicle. The driving controller may determine to cause the own vehicle to travel behind the second vehicle when the recognizer predicts that the second vehicle intends to follow the first vehicle.

(3) In the vehicle control device according to the aspect (2), the recognizer may predict that the second vehicle intends to follow the first vehicle when a distance between the first and second vehicles is less than a first distance and decreases by a first change degree or more.

(4) In the vehicle control device according to the aspect (2), the recognizer may predict that the second vehicle intends to follow the first vehicle when a distance between the first and second vehicles is less than a second distance and transitions within a second change degree.

(5) In the vehicle control device according to the aspect (2), the recognizer may predict that the second vehicle does not intend to follow the first vehicle when a distance between the first and second vehicles increases by a third change degree or more.

(6) In the vehicle control device according to the aspect (2), the recognizer may predict that the second vehicle does not intend to follow the first vehicle when the second vehicle is traveling behind the own vehicle and an external lighting device of the second vehicle performs a predetermined operation.

(7) In the vehicle control device according to the aspect (2), the recognizer may predict that the second vehicle does not intend to follow the first vehicle when a communicator performing inter-vehicle communication receives predetermined information from the second vehicle.

(8) In the vehicle control device according to the aspect (1), the driving controller may determine whether it is difficult to follow the second vehicle based on a state of the second traveling lane after the driving controller determines to cause the own vehicle to travel behind the second vehicle. The driving controller may cause the own vehicle to travel behind a third vehicle traveling behind the second vehicle in the second traveling lane when the driving controller determines that it is difficult to follow the second vehicle.

(9) In the vehicle control device according to the aspect (8), the driving controller may select a vehicle of which a distance with a following vehicle in the second traveling lane is equal to or greater than a third distance as the third vehicle.

(10) In the vehicle control device according to the aspect (1), the driving controller may perform an operation of directing a traveling direction of the own vehicle toward a second traveling lane or an operation of bringing a lateral position of the own vehicle near the second traveling lane side when the driving controller determines that it is difficult to enter the second traveling lane based on the state of the second traveling lane.

(11) In the vehicle control device according to the aspect (1), the driving controller may cause the own vehicle to repeat deceleration and acceleration when the driving controller determines that it is difficult to enter the second traveling lane based on the state of the second traveling lane.

(12) In the vehicle control device according to the aspect (10) based on the state of the second traveling lane, the driving controller may cause the own vehicle to enter the second traveling lane when the driving controller determines that it is not difficult to enter the second traveling lane after the driving controller determines that it is difficult to enter the second traveling lane.

(13) According to another aspect of the present invention, there is provided a vehicle control method including: recognizing a surrounding environment of an own vehicle by a recognizer; and determining, by a driving controller that performs driving control of the own vehicle with reference to a recognition result by the recognizer, whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the recognizer recognizes the first vehicle which is traveling in front of the own vehicle in a first traveling lane in which the own vehicle is traveling and the obstacle which is in front of the first vehicle.

(14) According to still another aspect of the present invention, there is provided a computer-readable non-transitory storage medium storing a program causing a computer mounted in an own vehicle to perform: recognizing a surrounding environment of the own vehicle; performing driving control of the own vehicle with reference to a recognition result; and determining whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the first vehicle which is traveling in front of the own vehicle in a first traveling lane in which the own vehicle is traveling and the obstacle which is in front of the first vehicle are recognized.

### Advantageous Effects of Invention

According to the aspects (1) to (14), it is possible to realize smoother obstacle avoidance.

According to the aspects (2) to (7), it is possible to appropriately determine whether approach to the second traveling lane is possible in accordance with a behavior or the like of the second vehicle.

According to the aspects (8) and (9), it is possible to smoothly transition to subsequent control even when it is difficult to follow the second vehicle.

According to the aspects (10) to (12), it is possible to raise a probability of approach to the second traveling lane by exposing an intention of the own vehicle M.

### BRIEF DESCRIPTION OF DRAWINGS

FIG. 1 is a diagram illustrating a configuration of a vehicle system in which a vehicle control device according to a first embodiment is used.

FIG. 2 is a diagram illustrating a functional configuration of a first controller and a second controller.

FIG. 3 is a flowchart illustrating an example of a flow of processes performed by an obstacle avoidance controller.

FIG. 4 is a diagram exemplifying a scenario in which traveling lanes are marked by road mark lanes.

FIG. 5 is a diagram exemplifying a scenario in which traveling lane are not marked by road mark lanes.

FIG. 6 is a diagram illustrating a relation between a first vehicle m1 and a second vehicle m2.

FIG. 7 is a diagram illustrating following control.

FIG. 8 is a flowchart illustrating an example of content of a process by an intention predictor.

FIG. 9 is a diagram illustrating a process of determining whether it is difficult to follow a second vehicle.

FIG. 10 is a continuation of the flowchart of FIG. 3.

FIG. 11 is a diagram (part 1) exemplifying a representation of an interruption.

FIG. 12 is a diagram (part 2) exemplifying a representation of an interruption.

FIG. 13 is a flowchart (part 1) illustrating an example of a flow of processes performed by the obstacle avoidance controller according to a second embodiment.

FIG. 14 is a flowchart (part 2) illustrating an example of a flow of processes performed by the obstacle avoidance controller according to the second embodiment.

FIG. 15 is a diagram illustrating an example of a hardware configuration of an automated driving control device according to each embodiment.

### DESCRIPTION OF EMBODIMENTS

Hereinafter, embodiments of a vehicle control device, a vehicle control method, and a storage medium according to the present invention will be described with reference to the drawings.

### First Embodiment

### [Overall Configuration]

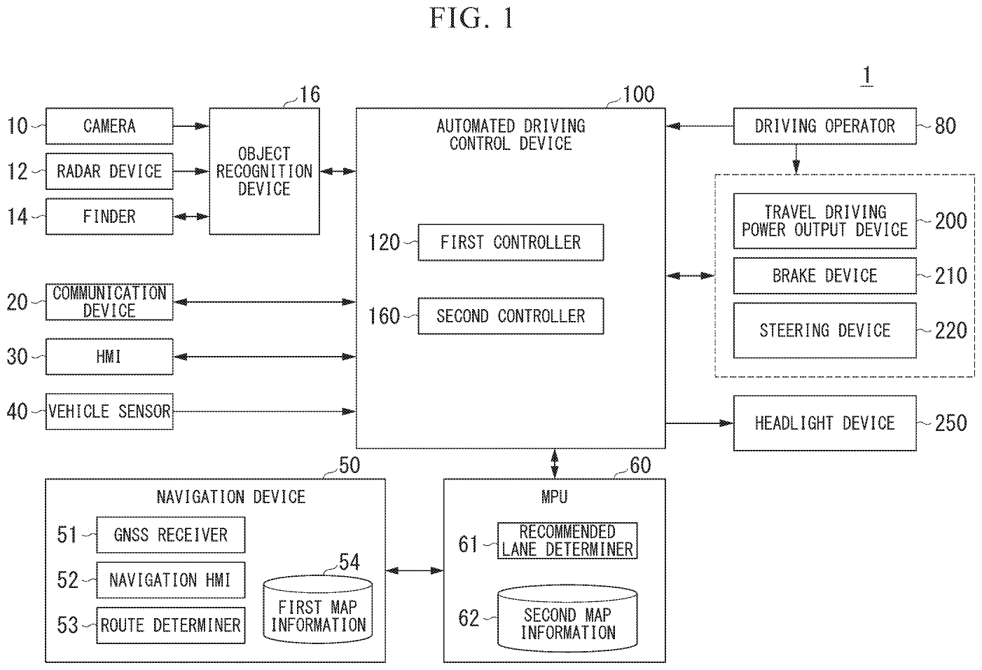

FIG. 1 is a diagram showing a configuration of a vehicle system 1 in which a vehicle control device according to a first embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. When the electric motor is included, the electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, a steering device 220, and a headlight device 250. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). One camera 10 or a plurality of cameras 10 are mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, or the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance from and an azimuth of) of the object. One radar device 12 or a plurality of radar devices 12 are mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. One finder 14 or a plurality of finders 14 are mounted on any portions of the own vehicle M. The finder 14 is an example of an object detection device.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change, as necessary.

The communication device 20 communicates with another vehicle around the own vehicle M or various server devices via radio base stations using, for example, a cellular network, a Wi-Fi network, Bluetooth (registered trademark), dedicated short range communication (DSRC) or the like.

The HMI 30 presents various types of information to occupants of the own vehicle M and receives input operations by the occupants. The HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map determined by the route determiner 53 is output to the MPU 60. The navigation device 50 may perform route guidance using the navigation HMI 52 based on the route on the map determined by the route determiner 53. The navigation device 50 may be realized by, for example, a function of a terminal device such as a smartphone or a tablet terminal possessed by an occupant. The navigation device 50 may transmit a present position and a destination to a navigation server via the communication device 20 to acquire the route on the map replied from the navigation server.

The MPU 60 functions as, for example, a recommended lane determiner 61 and retains second map information 62 in a storage device such as an HDD or a flash memory. The recommended lane determiner 61 divides the route provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route, a joining spot, or the like, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may access another device using the communication device 20 to be updated frequently.

The driving operator 80 includes, for example, an accelerator pedal, a brake pedal, a shift lever, a steering wheel, a heteromorphic steering wheel, a joystick, and other operators. A sensor that detects an operation amount or presence or absence of an operation is attached to the driving operator 80. A detection result is output to the automated driving control device 100 or some or all of the travel driving power output device 200, the brake device 210, and the steering device 220.

The automated driving control device 100 includes, for example, a first controller 120 and a second controller 160. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The automated driving control device 100 is an example of a vehicle control device.

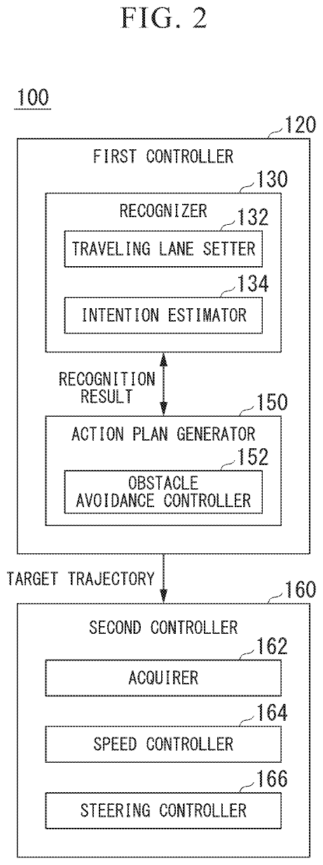

FIG. 2 is a diagram illustrating a functional configuration of the first controller 120 and the second controller 160. The first controller 120 includes, for example, a recognizer 130 and an action plan generator 150. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of driving support is guaranteed.

The recognizer 130 recognizes a surrounding situation of the own vehicle M based on information input from the camera 10, the radar device 12, and the finder 14 via the object recognition device 16. For example, the recognizer 130 recognizes states such as a position, a speed, acceleration, or the like of an object near the own vehicle M. For example, the position of the object is recognized as a position on the absolute coordinates in which a representative point (a center of gravity, a center of a driving shaft, or the like) of the own vehicle M is the origin and is used for control. The position of the object may be represented as a representative point such as a center of gravity, a corner, or the like of the object or may be represented as expressed regions. A “state” of an object may include an acceleration or jerk of the object or an “action state” (for example, whether a vehicle is changing a lane or is attempting to change the lane). The recognizer 130 recognizes the shape of a curve in which the own vehicle M passes from now based on images captured by the camera 10. The recognizer 130 converts the shape of the curve into an actual plane using the images captured by the camera 10 and outputs, for example, 2-dimensional point sequence information or information expressed using a model equal to the 2-dimensional point sequence information as information expressing the shape of the curve to the action plan generator 150.

The recognizer 130 recognizes, for example, a lane in which the own vehicle M is traveling (a traveling lane). For example, the recognizer 130 recognizes the traveling lane by comparing patterns of road mark lines (for example, arrangement of continuous lines and broken lines) obtained from the second map information 62 with patterns of road mark lines around the own vehicle M recognized from images captured by the camera 10. The recognizer 130 may recognize a traveling lane by recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M in the traveling lane when the recognizer 130 recognizes the traveling lane. For example, the recognizer 130 may recognize a deviation from the middle of a lane of the standard point of the own vehicle M and an angle formed with a line extending along the middle of a lane in the travel direction of the own vehicle M as a relative position and posture of the own vehicle M to the traveling lane. Instead of this, the recognizer 130 may recognize a position or the like of the standard point of the own vehicle M with respect to any side end portion (a road mark line or a road boundary) of a traveling lane as the relative position of the own vehicle M to the traveling lane.

The recognizer 130 may derive recognition precision in the foregoing recognition process and output the recognition precision as recognition precision information to the action plan generator 150. For example, the recognizer 130 generates the recognition precision information for a given period of time based on a frequency at which a road mark line can be recognized.

The recognizer 130 includes, for example, a traveling lane setter 132 and an intention predictor 134. For example, these functional units receive a request from an obstacle avoidance controller 152 of the action plan generator 150 and performs a process. This will be described later.

The action plan generator 150 determines events sequentially performed in automated driving so that the own vehicle M is traveling along a recommended lane determined by the recommended lane determiner 61 and can further handle a surrounding situation of the own vehicle M in principle. The action plan generator 150 generates a target trajectory in which the own vehicle M will travel in future in accordance with an activated event. The target trajectory includes, for example, a plurality of trajectory points and a speed element. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about every fractions of a second). The trajectory point may be a position at which the own vehicle M will arrive at the sampling time for each predetermined sampling time. In this case, information regarding the target acceleration or the target speed is expressed according to an interval between the trajectory points.

The action plan generator 150 includes, for example, the obstacle avoidance controller 152. This will be described later.

The second controller 160 controls the travel driving power output device 200, the brake device 210, and the steering device 220 such that the own vehicle M passes along a target trajectory generated by the action plan generator 150 at a scheduled time. A combination of the action plan generator 150 and the second controller 160 is an example of a “driving controller.”

The second controller 160 includes, for example, an acquirer 162, a speed controller 164, and a steering controller 166. The acquirer 162 acquires information regarding a target trajectory (trajectory points) generated by the action plan generator 150 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination.

The travel driving power output device 200 outputs travel driving power (toque) for causing a vehicle to travel to a driving wheel. The travel driving power output device 200 includes, for example, a combination of an internal combustion engine, an electric motor, and a transmission and an electronic control unit (ECU) controlling them. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal 84 included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Obstacle Avoidance Control]

Hereinafter, obstacle avoidance control by the vehicle system 1 will be described. The obstacle avoidance controller 152 performs control to avoid an obstacle when the obstacle is in front in a traveling lane of the own vehicle M with reference to a recognition result of the recognizer 130. In the following description, it is assumed that a “distance” is a distance between the rear end of an object which is in front and the front end of an object which is behind, that is, an “interval.” In other words, the “distance” is a concept equivalent to an “inter-vehicle distance.”

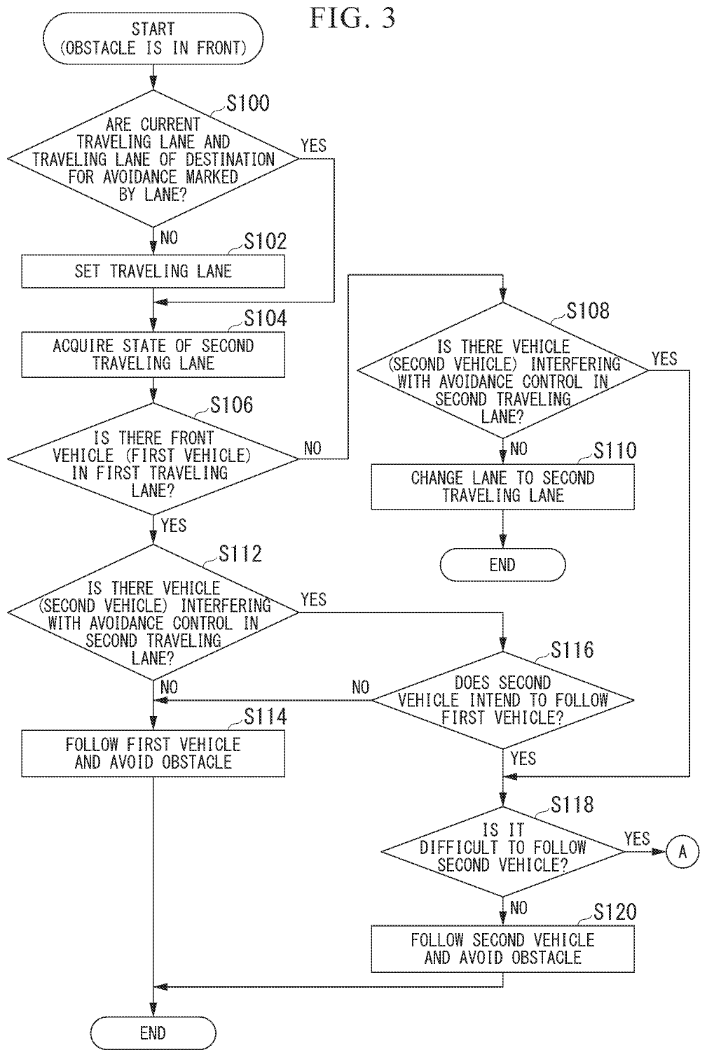

FIG. 3 is a flowchart illustrating an example of a flow of processes performed by the obstacle avoidance controller 152. The process of the flowchart starts when the recognizer 130 recognizes an obstacle in front of the own vehicle M. The front is a front within a predetermined range (for example, within 100 [m]) from the own vehicle M in the traveling lane of the own vehicle M. The obstacle is an object which is relatively motionless and has a height that would make it difficult for the own vehicle M to pass over it among objects recognized by the recognizer 130. Vehicles other than the own vehicle M include a four-wheeled vehicle, a two-wheeled vehicle, and a bicycle. The traveling lane will be described later.

First, the obstacle avoidance controller 152 determines whether a current traveling lane and a traveling lane of a destination to which the own vehicle moves to avoid an obstacle are marked by road mark lines with reference to a recognition result of the recognizer 130 (step S100). When the current traveling lane and the traveling lane of the destination to which the own vehicle moves to avoid the obstacle are not marked by road mark lines, the obstacle avoidance controller 152 requests the traveling lane setter 132 to set a traveling lane (step S102).

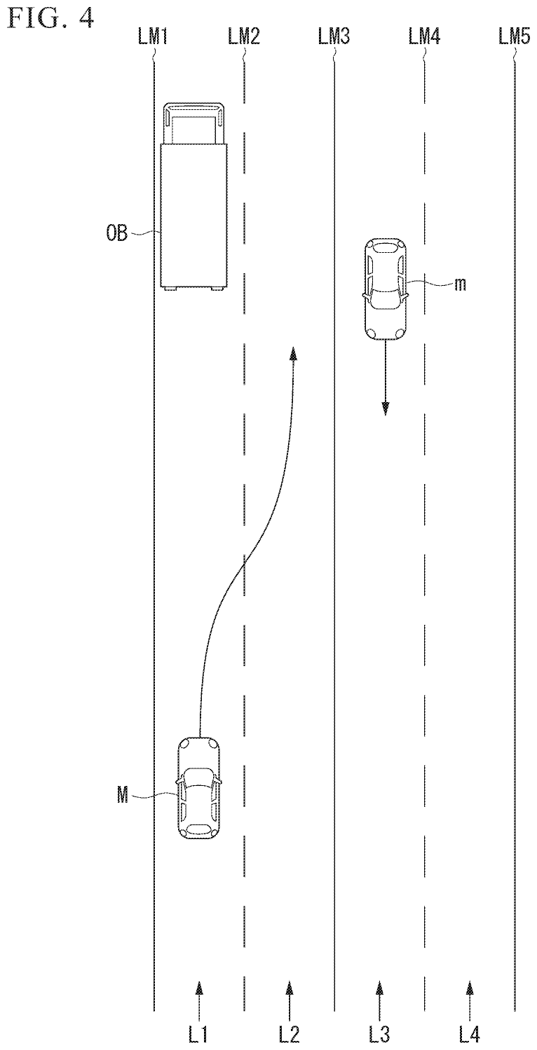

FIG. 4 is a diagram exemplifying a scenario in which traveling lanes are marked by road mark lines. In the drawing, L1 is a lane marked by road mark lines LM1 and LM2, L2 is a lane marked by road mark lines LM2 and LM3, L3 is a lane marked by road mark lines LM3 and LM4, and L4 is a lane marked by road mark lines LM4 and LM5. The lanes L1 and L2 are lanes in the traveling direction of the own vehicle M and the lanes L3 and L4 are oncoming lanes. Another vehicle m is traveling in the lane L3 which is the oncoming lane. The own vehicle M is traveling in the lane L1 and an obstacle OB (a large stopped vehicle in the drawing) is in front of the own vehicle M in the lane L1. The current traveling lane of the own vehicle M is the lane L1 and the traveling lane of the destination to which the own vehicle M moves to avoid the obstacle OB is the lane L2. In the scenario illustrated in FIG. 4, the obstacle avoidance controller 152 determines that the current traveling lane and the traveling lane of the destination to which the own vehicle M moves to avoid the obstacle are marked by the road mark lines. In the drawings after FIG. 4, an arrow connected to a vehicle is assumed to indicate a traveling direction of the vehicle.

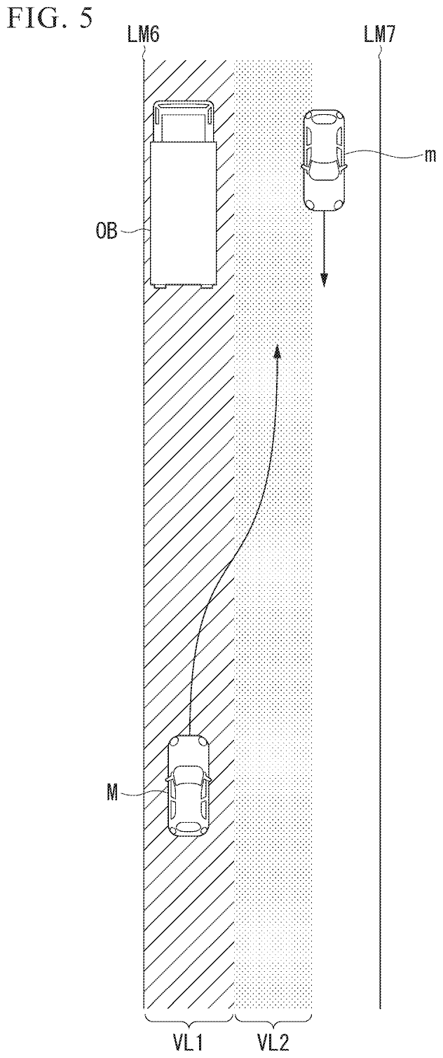

FIG. 5 is a diagram exemplifying a scenario in which traveling lanes are not marked by road mark lanes. A road illustrated in the drawing is a road that has a width in which two or three vehicles can travel in parallel and road mark lines are not formed other than road mark lines LM6 and LM7 of both ends. In the scenario illustrated in FIG. 5, the obstacle avoidance controller 152 determines that the current traveling lane and the traveling lane of the destination to which the own vehicle M moves to avoid the obstacle are not marked by road mark lines. In this case, for example, the traveling lane setter 132 sets virtual lanes VL1 and VL2 by using the vehicle width of the own vehicle M as a standard.

Hereinafter, the lane L1 in the scenario illustrated in FIG. 4 or the virtual lane VL1 in the scenario illustrated in FIG. 5 is an example of a “first traveling lane” and the lane L2 in the scenario illustrated in FIG. 4 or the virtual lane VL2 in the scenario illustrated in FIG. 5 is an example of a “second traveling lane.” The first traveling lane is a traveling lane in which the own vehicle M is traveling and the second traveling lane is a traveling lane in the same direction as the first traveling lane and a traveling lane in which the own vehicle travels to avoid the obstacle OB.

Referring back to FIG. 3, the obstacle avoidance controller 152 acquires a state of the second traveling lane from the recognizer 130 (step S104). Subsequently, the obstacle avoidance controller 152 determines whether there is a front vehicle traveling on the side of the own vehicle M and in front of the obstacle OB in the first traveling lane (hereinafter referred to as a first vehicle) (step S106). A condition for the first vehicle may be that a distance from the own vehicle M is within a predetermined distance.

When there is no first vehicle, the obstacle avoidance controller 152 determines whether a vehicle interfering with avoidance control (hereinafter referred to as a second vehicle) is in the second traveling lane (step S108). The vehicle interfering with the avoidance control in step S108 is, for example, a vehicle of which a distance from the own vehicle M is predicted to be within a predetermined distance at each future time point at which the own vehicle M will change its lane to the second traveling lane. In the present specification, description of interference from an oncoming vehicle will be omitted.

When there is no second vehicle in the second traveling, the obstacle avoidance controller 152 causes the own vehicle M to change its lane to the second traveling lane (step S110). In this case, for example, the obstacle avoidance controller 152 generates a plurality of spline curves in which a position, a speed of the own vehicle M and a target arrival spot in the second traveling lane, and the like are used as parameters, selects a spline curve in which a minimum approach distance to the obstacle OB or a maximum steering angle are optimized, and sets the spline curve as a target trajectory.

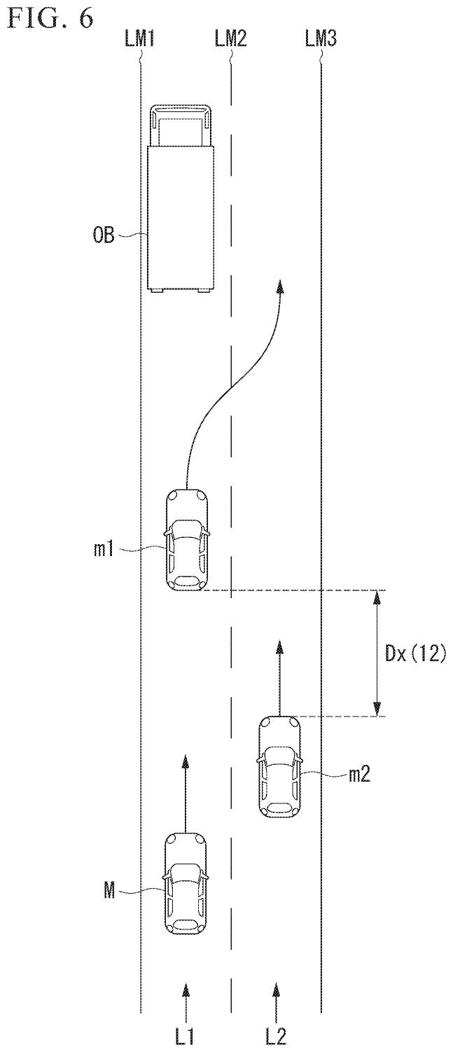

When it is determined in step S106 that there is the first vehicle, the obstacle avoidance controller 152 determines whether a vehicle interfering with the avoidance control (hereinafter referred to as a second vehicle) is in the second traveling lane (step S112). The vehicle interfering with the avoidance control in step S112 is a vehicle of which a distance from the own vehicle M is predicted to be within a predetermined distance, for example, at each future time point at which the own vehicle M is assumed to follow the first vehicle and enter the second traveling lane. FIG. 6 is a diagram illustrating a relation between the first vehicle m1 and the second vehicle m2. In the drawing, Dx(12) is a distance between the first vehicle m1 and the second vehicle m2 in the traveling direction. This will be described later. In subsequent drawings, it is assumed that the own vehicle M is traveling on a road in which the first traveling lane and the second traveling lane are marked by a road mark line LM and the oncoming lane is not illustrated.

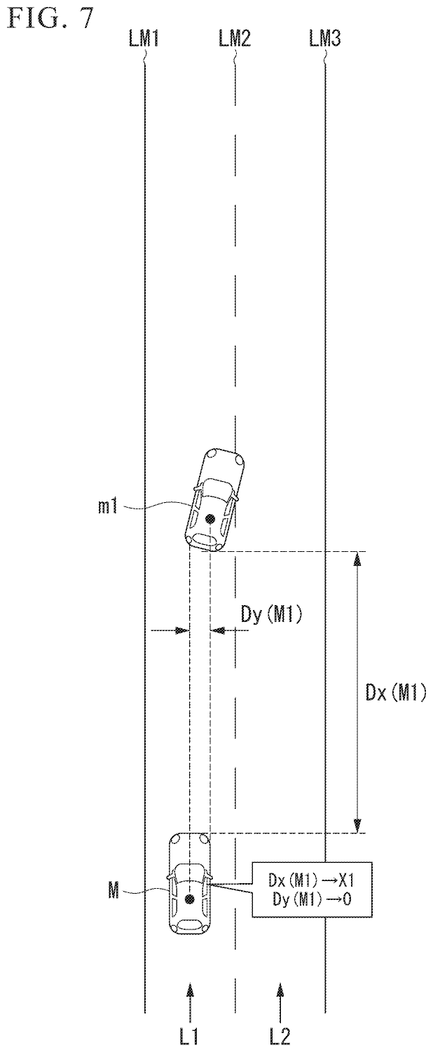

Here, “following” means traveling behind a front vehicle while maintaining the same lateral position and maintaining an inter-vehicle distance at which it would be difficult for another vehicle to come between them. The lateral position is a displacement in the width direction of a road. FIG. 7 is a diagram illustrating following control. In the drawing, Dx(M1) is a distance (an inter-vehicle distance) between the own vehicle M and the first vehicle m1 in the traveling direction and Dy(M1) is a difference between lateral positions of the own vehicle M and the first vehicle m1. Dy(M1) is recognized by comparing representative points (centers of gravity, centers of driving shafts, or the like) of the vehicles. When the own vehicle M follows the first vehicle m1, the obstacle avoidance controller 152 performs feedback control such that, for example, the distance Dx(M1) is close to a constant value X1 and the difference Dy(M1) between the lateral positions approaches zero. The following control is easier than generation of a target trajectory by the own vehicle in consideration of various elements. Therefore, by performing the following control in a complex situation such as obstacle avoidance, it is possible to reduce a process load of an automated driving vehicle. A scenario in which the own vehicle M cannot move in the lateral direction immediately, for example, the own vehicle M overlaps the first vehicle m1 in the traveling direction or the own vehicle M is traveling in front of the first vehicle m1 occurs. However, in this case, the own vehicle M waits until the own vehicle M can move in the lateral direction by prioritizing adjustment of the inter-vehicle distance.

When it is determined in step S112 that there is no second vehicle, the obstacle avoidance controller 152 causes the own vehicle M to follow the first vehicle and avoid the obstacle OB (step S114).

When it is determined in step S112 that there is the second vehicle, the obstacle avoidance controller 152 requests the intention predictor 134 to perform prediction and determines whether the second vehicle intends to follow the first vehicle (step S116).

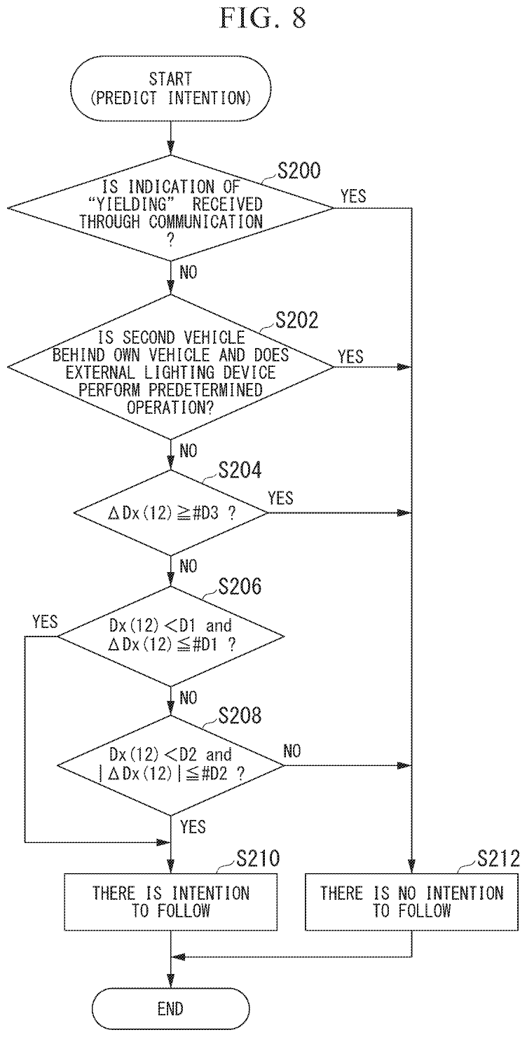

FIG. 8 is a flowchart illustrating an example of content of a process by the intention predictor 134. First, the intention predictor 134 determines whether information indicating “yielding” of a route is received from the second vehicle through inter-vehicle communication (step S200). When the information indicating “yielding” of the route is received from the second vehicle through the inter-vehicle communication, the intention predictor 134 predicts that the second vehicle does not intend to follow the first vehicle (step S212).

When a negative result is determined in step S200, the intention predictor 134 determines whether the second vehicle is traveling behind the own vehicle M and an external lighting device performs a predetermined operation (step S202). For example, the phrase “the second vehicle is traveling behind the own vehicle M” means that the front end of the second vehicle is located behind the rear end of the own vehicle M in the traveling direction. The phrase “the external lighting device performs the predetermined operation” means that, for example, a headlight is switched from a low-beam state to a high-beam state several times or a hazard lamp is activated. When a positive result is determined in step S202, the intention predictor 134 predicts that the second vehicle does not intend to follow the first vehicle (step S212). This is because this operation indicates a message indicating that a driver of the second vehicle permits the own vehicle M to enter first after the first vehicle.

When a negative result is obtained in step S202, the intention predictor 134 determines whether a distance between the first and second vehicles increases a third change degree or more. Specifically, the intention predictor 134 determines whether a change amount ΔDx(12) within a standard time of the distance Dx(12) between the first and second vehicles is equal to or greater than a threshold #D3 (step S204). When the change amount ΔDx(12) within the standard time of the distance Dx(12) between the first and second vehicles is equal to or greater than the threshold #D3, the intention predictor 134 predicts that the second vehicle does not intend to follow the first vehicle (step S212). This is because when the distance Dx(12) between the first and second vehicles increases rapidly, the second vehicle is predicted not to intend to follow the first vehicle.

When a negative result is determined in step S204, the intention predictor 134 determines whether the distance between the first and second vehicles is less than a first distance and decreases by the first change degree or more. Specifically, the intention predictor 134 determines whether the distance Dx(12) between the first and second vehicles is less than a threshold D1 and a change amount ΔDx(12) within the standard time of the distance D is equal to or less than a threshold #D1 (step S206). The threshold #D1 is a negative value. When a positive result is determined in step S206, the second vehicle is in the middle of reducing the inter-vehicle distance with the first vehicle. Therefore, the intention predictor 134 predicts that the second vehicle intends to follow the first vehicle (step S210).

When a negative result is determined in step S206, the intention predictor 134 determines whether the distance between the first and second vehicles is less than the second distance and transitions within a second change degree. Specifically, the intention predictor 134 determines whether the distance Dx(12) between the first and second vehicles is less than a threshold D2 and an absolute value |ΔDx(12)| of the change amount ΔDx(12) within the standard time of the distance Dx(12) is equal to or less than the threshold #D2 (step S208). When a positive result is determined in step S208, the second vehicle has already reduced the inter-vehicle distance with the first vehicle and maintains this state. Therefore, the intention predictor 134 predicts that the second vehicle intends to follow the first vehicle (step S210). Conversely, when a negative result is determined in step S208, the intention predictor 134 predicts that the second vehicle does not intend to follow the first vehicle (step S212).

Here, the threshold D1>the threshold D2 is satisfied. The absolute value of the threshold #D1>the threshold #D2 is satisfied and the absolute value of the threshold #D3>the threshold #D2 is satisfied. Any one of the absolute value of the threshold #D1 and the absolute value of the threshold #D3 may be greater.

Referring back to FIG. 3, when it is determined in step S116 that the second vehicle does not intend to follow the first vehicle as a result of the prediction by the intention predictor 134, the obstacle avoidance controller 152 causes the own vehicle M to follow the first vehicle and avoid the obstacle OB (step S114).

Conversely, when it is determined in step S116 that the second vehicle intends to follow the first vehicle as a result of the prediction by the intention predictor 134 or it is determined in step S108 that the second vehicle is in the second traveling lane, the obstacle avoidance controller 152 determines whether it is difficult to follow the second vehicle (step S118).

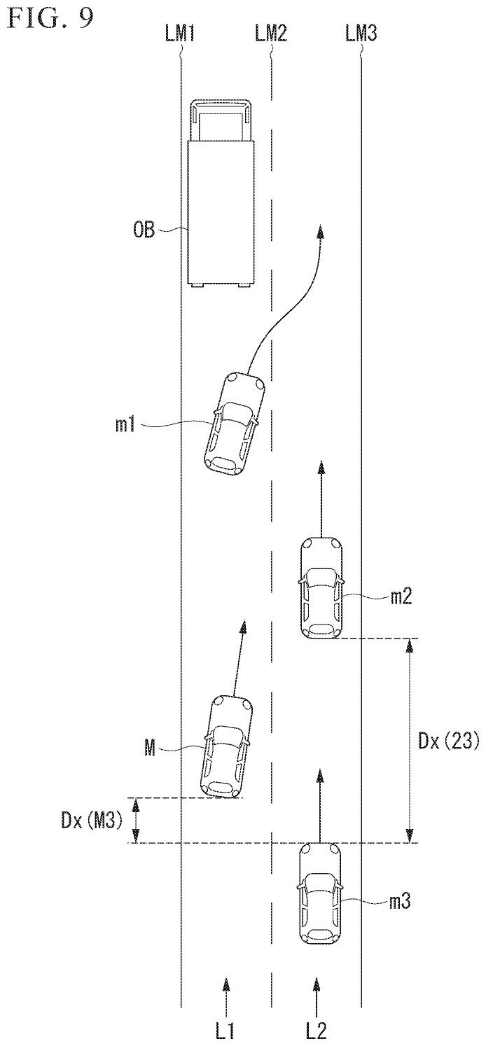

FIG. 9 is a diagram illustrating a process of determining whether it is difficult to follow the second vehicle. In the drawing, a third vehicle m3 is traveling immediately behind the second vehicle m2 in the lane L2 which is the second traveling lane. In such a scenario, the obstacle avoidance controller 152 determines that it is not difficult to follow the second vehicle, for example, when a distance Dx(23) between the second vehicle m2 and the third vehicle m3 is equal to or greater than a threshold and a value obtained by dividing a distance Dx(M3) between the own vehicle M and the third vehicle m3 by a relative speed ΔV (a speed of the third vehicle m3 minus a speed of the own vehicle M) of the own vehicle M to the third vehicle m3 is equal to or greater than a threshold. The obstacle avoidance controller 152 determines that it is difficult to follow the second vehicle when the distance Dx(23) between the second vehicle m2 and the third vehicle m3 is less than a threshold and the value obtained by dividing a distance Dx(M3) between the own vehicle M and the third vehicle m3 by the relative speed ΔV of the own vehicle M to the third vehicle m3 is less than the threshold.

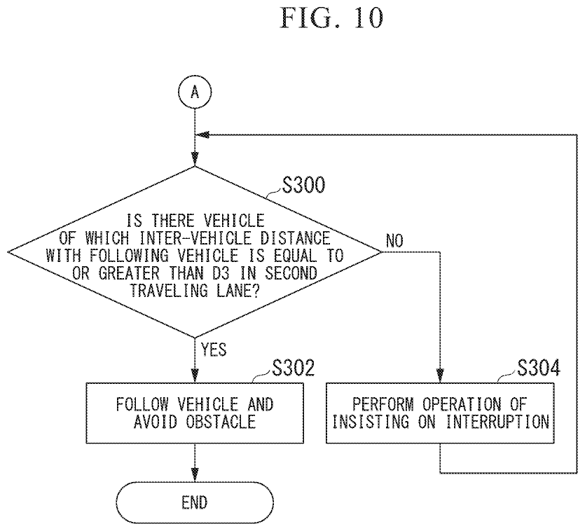

When the obstacle avoidance controller 152 determines that it is not difficult to follow the second vehicle, the obstacle avoidance controller 152 causes the own vehicle M to follow the second vehicle and avoid the obstacle OB (step S120). The case in which it is determined that it is difficult to follow the second vehicle will be described with reference to FIG. 10.

FIG. 10 is a continuation of the flowchart of FIG. 3. When the obstacle avoidance controller 152 determines in step S118 that it is difficult to follow the second vehicle, the obstacle avoidance controller 152 determines whether there is a vehicle (a third vehicle) of which an inter-vehicle distance with a following vehicle is equal to or greater than a threshold D3 (a third distance) in the second traveling lane (step S300).

When there is a vehicle of which the inter-vehicle distance with the following vehicle is equal to or greater than the threshold D3, the obstacle avoidance controller 152 selects the vehicle causes the own vehicle M to follow the vehicle and avoid the obstacle OB (step S302).

Conversely, when the obstacle avoidance controller 152 determines that there is no vehicle of which the inter-vehicle distance with the following vehicle is equal to or greater than the threshold D3 in the second traveling lane, the obstacle avoidance controller 152 causes the own vehicle M to perform an operation of insisting on an interruption (step S304) and the process returns to step S300.

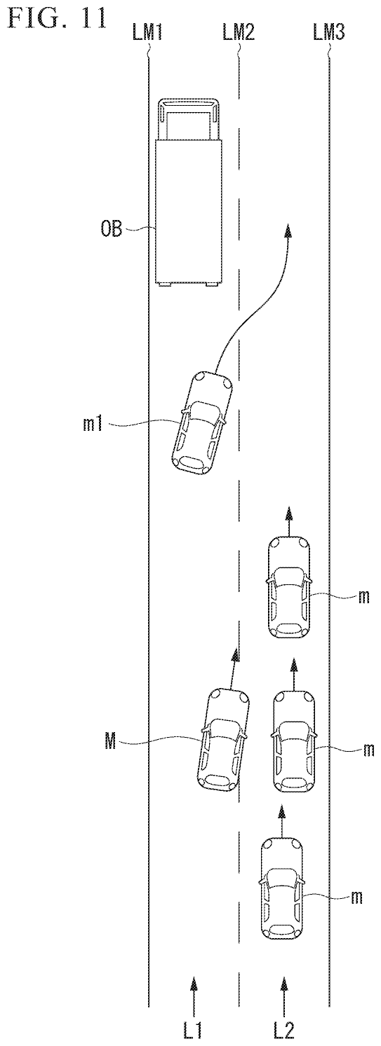

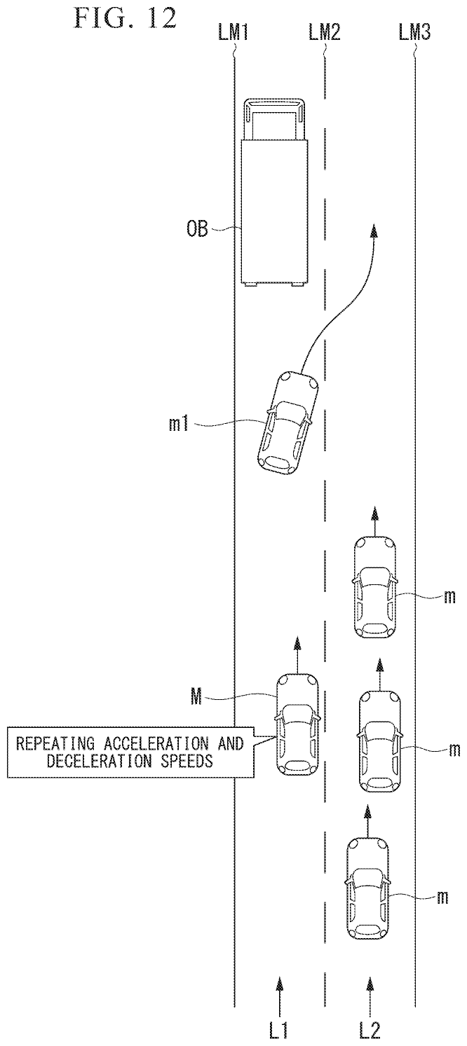

FIGS. 11 and 12 are diagrams exemplifying a representation of an interruption. As illustrated in FIG. 11, the obstacle avoidance controller 152 may cause the own vehicle M to perform an operation of directing the traveling direction of the own vehicle M toward the second traveling lane and/or bringing the lateral position of the own vehicle M near the second traveling lane side in a stage in which a following vehicle is not determined as the operation of insisting on the interruption.

As illustrated in FIG. 12, the obstacle avoidance controller 152 may cause the own vehicle M to perform an operation of causing the own vehicle M to repeat deceleration and acceleration in a stage in which a following vehicle is not determined as the operation of insisting on the interruption.

By performing the operation of insisting on the interruption, the vehicle traveling in the second traveling lane can recognize that the own vehicle M is scheduled to enter the second traveling lane. As a result, it is expected that one vehicle broadens the inter-vehicle distance with a front vehicle and the own vehicle M is permitted to be able to enter the second traveling lane. As a result, it is possible to raise a probability of the own vehicle M being able to enter the second traveling lane.

The vehicle control device according to the above-described first embodiment can realize smoother obstacle avoidance.

### Second Embodiment

In the first embodiment, the intention predictor 134 is included and step S116 of the flowchart of FIG. 3 is determined based on a result of the prediction by the intention predictor 134 in the flowchart of FIG. 8, as described above. In a second embodiment, the intention predictor 134 is omitted and the obstacle avoidance controller 152 performs the same processes as those of the flowchart of FIG. 8.

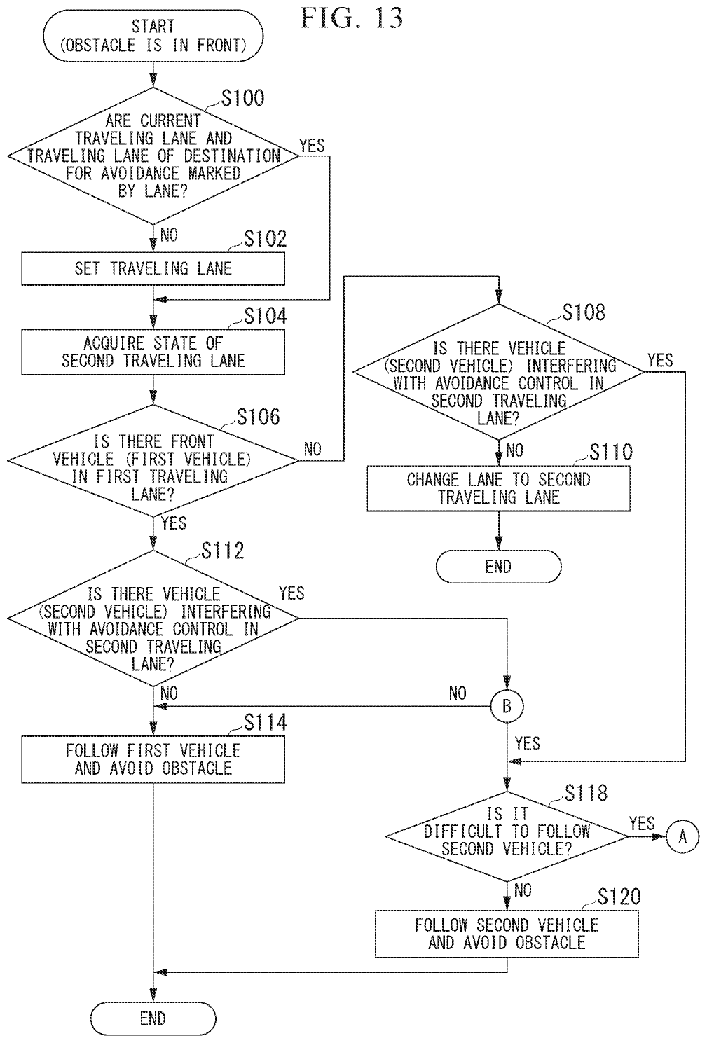

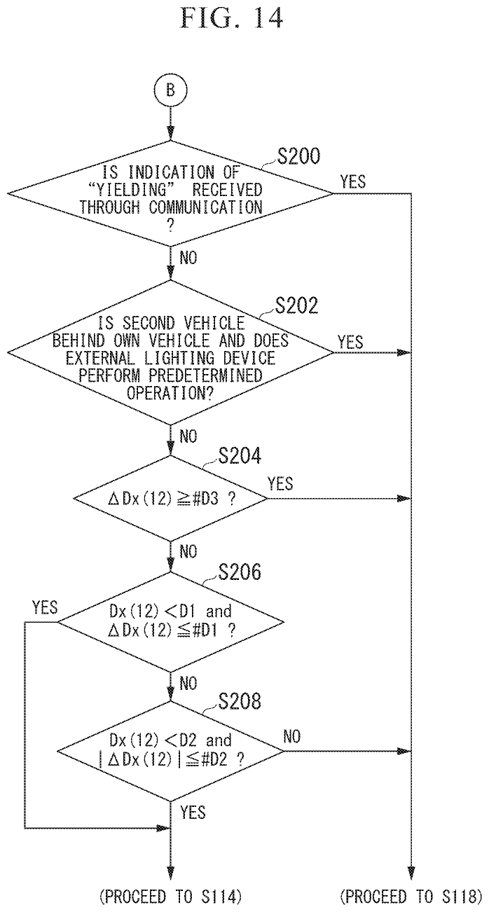

FIGS. 13 and 14 are flowcharts illustrating examples of flows of processes performed by the obstacle avoidance controller 152 according to the second embodiment. In FIGS. 13 and 14, since the same processes as those of the flowcharts of FIGS. 3 and 8 are performed in the steps to which the same step numbers as those of the flowcharts of FIGS. 3 and 8 are given, individual description will be omitted.

In FIG. 13, when it is determined that there is the vehicle (the second vehicle) interfering with the avoidance control in the second traveling lane, the obstacle avoidance controller 152 performs the processes of the flowchart of FIG. 14. When the positive result is determined in any one of steps S200, S202, and S204, the obstacle avoidance controller 152 causes the process to proceed to step S118. When the negative result is determined in steps S200, S202, and S204 and the positive result is determined in any one of steps S206 and S208, the obstacle avoidance controller 152 causes the process to proceed to step S114. When the negative result is determined in steps S206 and S208, the obstacle avoidance controller 152 causes the process to proceed to step S118.

The second embodiment can be expressed as follows.

(A) A vehicle control device includes:

a recognizer configured to recognize a surrounding environment of an own vehicle; and

a driving controller configured to perform driving control of the own vehicle with reference to a recognition result by the recognizer and configured to determine whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the recognizer recognizes the first vehicle which is traveling in front of the own vehicle in a first traveling lane in which the own vehicle is traveling and the obstacle which is in front of the first vehicle.

(B) In the vehicle control device of (A), the driving controller may cause the own vehicle to travel behind the second vehicle when a distance between the first and second vehicles decreases by a first change degree or more.

(C) In the vehicle control device of (A), the driving controller may cause the own vehicle to travel behind the second vehicle when a distance between the first and second vehicles is less than a first distance and transitions within a second change degree.

(D) In the vehicle control device of (A), the driving controller may cause the own vehicle to travel behind the first vehicle when a distance between the first and second vehicles increases by a third change degree or more.

(E) In the vehicle control device of (A), the own vehicle may be caused to travel behind the first vehicle when an external lighting device of the second vehicle performs a predetermined operation.

(F) In the vehicle control device of (A), the driving controller may cause the own vehicle to travel behind the first vehicle when a communicator performing inter-vehicle communication receives predetermined information from the second vehicle.

As in the first embodiment, the vehicle control device according to the above-described second embodiment can realize the smoother obstacle avoidance.

### <Hardware Configuration>

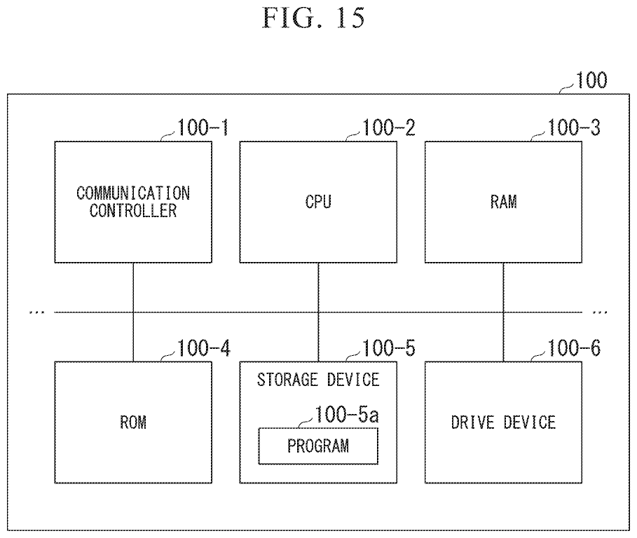

FIG. 15 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, one or both of the recognizer 130 and the action plan generator 150 are realized.

### <Others>

In the foregoing embodiments, the vehicle control device performs the so-called automated driving to automatedly perform speed control, obstacle avoidance, lane changing, and the like, as described above. However, the vehicle control device may be based on a device that performs driving support control such as adaptive cruise control (ACC), a lane keeping assist system (LKAS), and auto lane change (ALC). In this case, for example, when an obstacle is detected in the first traveling lane during execution of ACC, the vehicle control device may switch between following of the first vehicle to avoid of the first vehicle by using the ACC function and lane changing to the second traveling lane by using the ALC function.

The above-described embodiments can be expressed as follows:

a vehicle control device including a storage device that stores a program and a hardware processor, the hardware processor executing the program stored in the storage device to perform:

recognizing a surrounding environment of an own vehicle; and

determining whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when a recognizer recognizes the first vehicle which is traveling in front of the own vehicle in a first traveling lane in which the own vehicle is traveling and the obstacle which is in front of the first vehicle.

The embodiments for carrying out the present invention have been described above, but the present invention is not limited to the embodiments. Various modifications and substitutions can be made within the scope of the present invention without departing from the gist of the present invention.

What is claim is:

1. A vehicle control device comprising:
a recognizer configured to recognize a surrounding environment of an own vehicle; and
a driving controller configured to perform driving control of the own vehicle with reference to a recognition result from the recognizer and configured to determine whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the recognizer recognizes the first vehicle which is traveling in front of the own vehicle in a first traveling lane in which the own vehicle is traveling and the obstacle which is in front of the first vehicle.

2. The vehicle control device according to claim 1,
wherein the recognizer predicts whether the second vehicle intends to follow the first vehicle based on a state of the second vehicle, and
wherein the driving controller determines to cause the own vehicle to travel behind the second vehicle when the recognizer predicts that the second vehicle intends to follow the first vehicle.

3. The vehicle control device according to claim 2,
wherein the recognizer predicts that the second vehicle intends to follow the first vehicle when a distance between the first and second vehicles is less than a first distance and decreases by a first change degree or more.

4. The vehicle control device according to claim 2,
wherein the recognizer predicts that the second vehicle intends to follow the first vehicle when a distance between the first and second vehicles is less than a second distance and transitions within a second change degree.

5. The vehicle control device according to claim 2,
wherein the recognizer predicts that the second vehicle does not intend to follow the first vehicle when a distance between the first and second vehicles increases by a third change degree or more.

6. The vehicle control device according to claim 2,
wherein the recognizer predicts that the second vehicle does not intend to follow the first vehicle when the second vehicle is traveling behind the own vehicle and an external lighting device of the second vehicle performs a predetermined operation.

7. The vehicle control device according to claim 2,
wherein the recognizer predicts that the second vehicle does not intend to follow the first vehicle when a communicator performing inter-vehicle communication receives predetermined information from the second vehicle.

8. The vehicle control device according to claim 1,
wherein the driving controller determines whether it is difficult to follow the second vehicle based on a state of the second traveling lane after the driving controller determines to cause the own vehicle to travel behind the second vehicle, and the driving controller causes the own vehicle to travel behind a third vehicle traveling behind the second vehicle in the second traveling lane when the driving controller determines that it is difficult to follow the second vehicle.

9. The vehicle control device according to claim 8,
wherein the driving controller selects a vehicle of which a distance with a following vehicle in the second traveling lane is equal to or greater than a third distance as the third vehicle.

10. The vehicle control device according to claim 1,
wherein the driving controller performs an operation of directing a traveling direction of the own vehicle toward a second traveling lane or an operation of bringing a lateral position of the own vehicle near the second traveling lane side when the driving controller determines that it is difficult to enter the second traveling lane based on the state of the second traveling lane.

11. The vehicle control device according to claim 1,
wherein the driving controller causes the own vehicle to repeat deceleration and acceleration when the driving controller determines that it is difficult to enter the second traveling lane based on the state of the second traveling lane.

12. The vehicle control device according to claim 10,
wherein, based on the state of the second traveling lane, the driving controller causes the own vehicle to enter the second traveling lane when the driving controller determines that it is not difficult to enter the second traveling lane after the driving controller determines that it is difficult to enter the second traveling lane.

13. A vehicle control method comprising:
recognizing a surrounding environment of an own vehicle by a recognizer; and
determining, by a driving controller that performs driving control of the own vehicle with reference to a recognition result from the recognizer, whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the recognizer recognizes the first vehicle which is traveling in front of the own vehicle in a first traveling lane in which the own vehicle is traveling and the obstacle which is in front of the first vehicle.

14. A computer-readable non-transitory storage medium storing a program causing a computer mounted in an own vehicle to perform:
recognizing a surrounding environment of the own vehicle;
performing driving control of the own vehicle with reference to a recognition result; and
determining whether the own vehicle is caused to travel behind a first vehicle or the own vehicle is caused to travel behind a second vehicle traveling in a second traveling lane based on a state of the second traveling lane of a destination to which the first vehicle moves to avoid an obstacle by steering when the first vehicle which is traveling in front of the own vehicle in a first traveling lane in which the own vehicle is traveling and the obstacle which is in front of the first vehicle are recognized.
